(19) United States
(12) Patent Application Publication
(10) Pub. No.: US 2008/0093420 A1
(43) Pub. Date: Apr. 24, 2008

(54) Process for the Friction-Welding of Components

(75) Inventor: Dieter Mauer, Lollar (DE)

Correspondence Address: BIRCH STEWART KOLASCH & BIRCH, PO BOX 747, FALLS CHURCH, VA, 22040-0747, US

(73) Assignee: EJOT GMBH & CO. KG, LAASPHE (DE)

(21) Appl. No.: 11/632,043

(22) PCT Filed: Jul. 18, 2005
(86) PCT No.: PCT/EP05/07812

§ 371 Date: May 19, 2007

(30) Foreign Application Priority Data
Jul. 16, 2004 (DE) 10 2004 034 198.1

(51) Int. Cl. B23K 20/12

(52) U.S. Cl. 228/114

(57) ABSTRACT

The invention relates to a method for friction welding components (35) during which both components are rotated relative to one another during a heating phase under mutual axial pressing force (F) generated by a pressing force actuator (8a) at the location to be welded when component (3) is at rest and when driven component (5) is rotating. In addition, after the components (3, 5) have been subjected to a sufficient friction heating, the rotating is slowed down and the components, which are stationary with regard to one another, are pressed together with a pressing force that is significantly greater than that during the heating phase. The rotated component (5) is driven by an electric motor (7), which is provided with a controller (19) and whose rotational speed (n), torque (RF), pressing force (F) and advancing depth (S) are measured by the controller. The rotational speed is, according to an axial initial pressing force (F) between both components, set by the controller to an initial rotational speed that causes the contact surfaces of both components to melt, and is maintained until the torque drops as a result of the melting of the contact surfaces of both components, during which the rotational speed is decreased and is reduced to zero. Once the rotational speed is zero, the pressing force is increased to a maximum so that the fixed welding ensues on the contact surfaces of both components.

The invention relates to a process for the friction-welding of components in which, during a heating phase and under reciprocal axial pressing force produced by a pressing-force actuator, the two components are rotated in relation to each other at the site to be welded, one component being stationary and the driven component being rotated, wherein, furthermore, after sufficient friction heating of the components, the rotation is braked and the parts, stationary with respect to each other, are pressed together with considerably greater pressing force than during the heating phase, the rotated component being driven by an electric motor provided with a controller, the speed, torque, pressing force and feed depth of said electric motor being measured by the controller.

Such a process is described in DE 199 02 357A1. Said publication generally describes the above-explained process with reference to a control for a friction-welding machine which takes account of the friction torque or friction power during the friction phase. In addition, it is generally mentioned in the description of the publication that the control comprises a plurality of components. These are, on the one hand, a torque/power recorder, a torque computer or power computer, a friction torque regulator, a feed regulator or pressure regulator and a feed sensor or pressure sensor. The regulating system acts upon the feed control. With regard to any values or any interdependencies, it is merely mentioned in the description that a setpoint value for the friction torque and/or friction power may be constant. It can, however, alternatively be represented as any desired function with respect to friction time, friction travel or friction angle or feed travel or any other suitable parameters. Accordingly, the feed drive is controlled by the regulating system for setting the desired friction torque and/or friction power. This information contains only the teaching as to which components or parameters the friction-welding operation may be based on, without it thus being indicated what concrete findings or measurement results of the individual sensors can be used as key values and, in a certain manner, for control purposes.

Building thereon, DE 299 22 424 U1 discloses a process according to which, during the actual friction process, the speed of the rotated component is constantly changed such that the friction factor is thereby increased, this allowing optimal energy utilization through adaptation of the value thereof, it being possible for the speed to be either reduced or increased during the friction process, depending on the material combination and friction-welding application.

This is the starting point for the invention, which discloses a process with the required individual process values which concretely determine the sequence of a safe and reliable friction-welding process. These process features consist in that, depending on an axial initial pressing force (F) between the two components, the speed (n) is adjusted by the controller to an initial speed (n) causing the part-melting of the contact surfaces of the two components and is maintained up until a torque drop occurring as a consequence of melting of the contact surfaces of the two components, upon which torque drop the speed is lowered and reduced down to a standstill, wherein, at the end of reduction, the pressing force (F) is increased up to a maximum so that the strong welded connection is achieved at the contact surfaces of the two components.

With these process steps, the controller first of all sets an initial speed which is stored in the controller, said initial speed depending on an axial initial pressing force of the two components. Said initial speed and the axial initial pressing force then give rise to the friction required between the two components for the friction-welding operation until the contact surfaces begin to melt, this leading to a clearly noticeable drop in torque, upon determination of which the speed is lowered and reduced down to a standstill by the controller, the measurement of the torque drop being the signal, therefore, for the reduction in speed. When the reduction in speed, which cannot proceed abruptly, then results in the speed approaching and reaching a standstill, the axial pressing force is increased up to a defined maximum just before or upon standstill of the speed, as a consequence of which said increased pressure then becomes effective at the contact surfaces of the two components, thereby bringing about the final strong welded connection.

The invention further relates to a device for implementing the above-described process. Said device is advantageously of such design that the axis of the electric motor transitions axially into the rotation axis of the driven component. This direct connection between the axis of the electric motor and the rotation axis of the driven component results in a connection which is free from undesired mass inertia forces and which allows no slip whatsoever. Preferably, said transition from the axis of the electric motor into the rotation axis of the driven component is of such design that the electric motor and the driven component are axially rigidly interconnected.

Depending on the type of electric motor used, it may also be advantageous to connect a non-slip gear unit between the electric motor and the driven component, said gear unit taking into consideration the particular speeds of the electric motor used.

In order to obtain the axial feed of the drive of the driven component required for welding of the two components, the electric motor with the pressing-force actuator is advantageously carried by a linear feed apparatus. The electric motor may be provided with a pressing-force sensor to indicate the pressing force with which the driven component is pressed against the stationary component.

In order to be able to check the interpenetration of driven component and stationary component, the feed apparatus is advantageously provided with a travel sensor. This is of importance particularly where the stationary component is a thin metal plate.

In order to allow the controller of the electric motor with its feed apparatus to become appropriately effective, the electric motor, the travel sensor and the pressing-force sensor are connected into a control loop containing the controller, said sensors supplying the controller with measured data indicating the torque, speed, travel and pressing force, wherein the electric motor and the feed apparatus are adjusted on the basis of the measurement of said measured data, the torque and speed being determined directly on the basis of a measurement of the electric current supplied to the electric motor.

The process and device according to the invention may advantageously be used to weld studs to panel-type components, the studs forming the driven component and the panel-type components forming the stationary component. In such a case, the device is provided with a receiving means for the studs, such as a chuck, and an abutment for the panel-type components, wherein said abutment may be provided in particular with a flat surface.

The device is advantageously of such design that the panel-type component is pressed against the abutment by a downholder and is thereby clamped in order thus to bring the panel-type component into a defined position in which it is then held down by the downholder. Furthermore, the device is advantageously provided with a feeding device for feeding the studs, so that the device can be expediently employed particularly in serial production.

For the design of the device, use is advantageously made of a C-shaped arm which, on the one hand, forms the abutment and, on the other hand, is connected to the feed apparatus.

In order to obtain an advantageous design of the device, it is possible to provide a pressing-force actuator, said pressing-force actuator being in the form of a toggle joint connection, the articulated levers of which move either towards or away from each other by a threaded adjusting rod during motor-driven rotation. The toggle joint connection makes it possible to produce a very accurate displacement of the driven component and also a high pressing force.

Illustrative embodiments of the invention are presented in the drawings, in which:

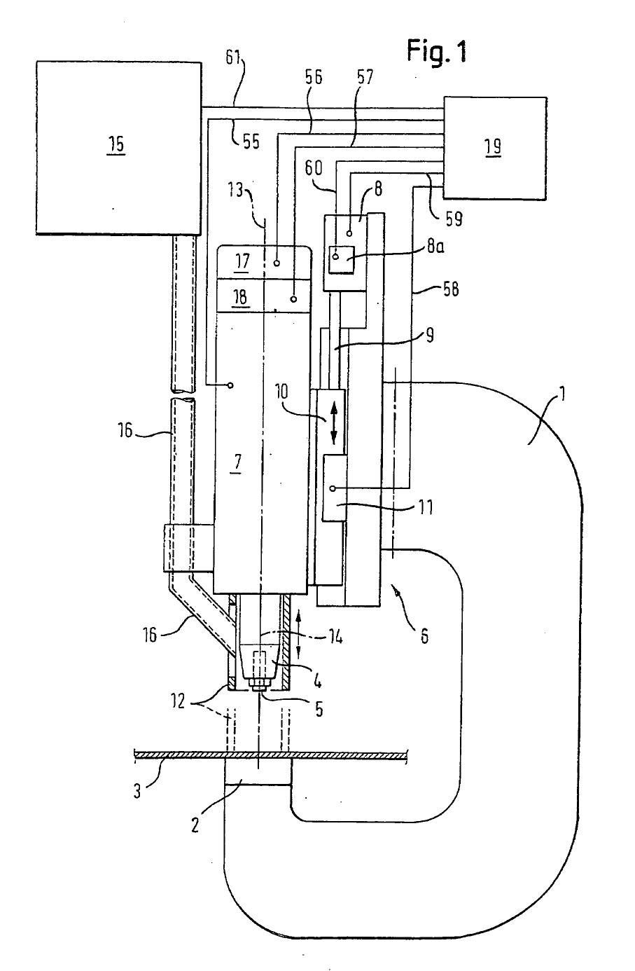

FIG. 1 shows the device for implementing the process according to the invention, with reference to the friction-welding of a stud on a panel;

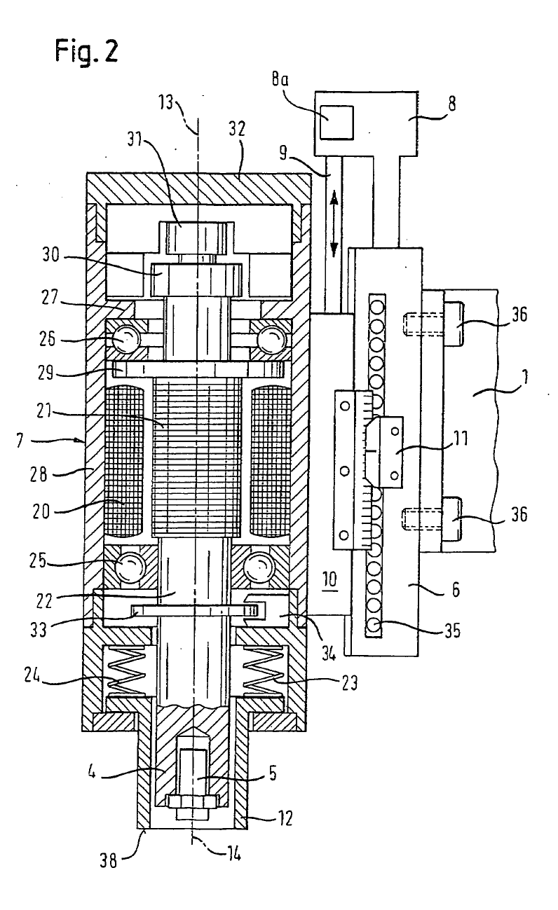

FIG. 2 shows a partial section through the device according to FIG. 1;

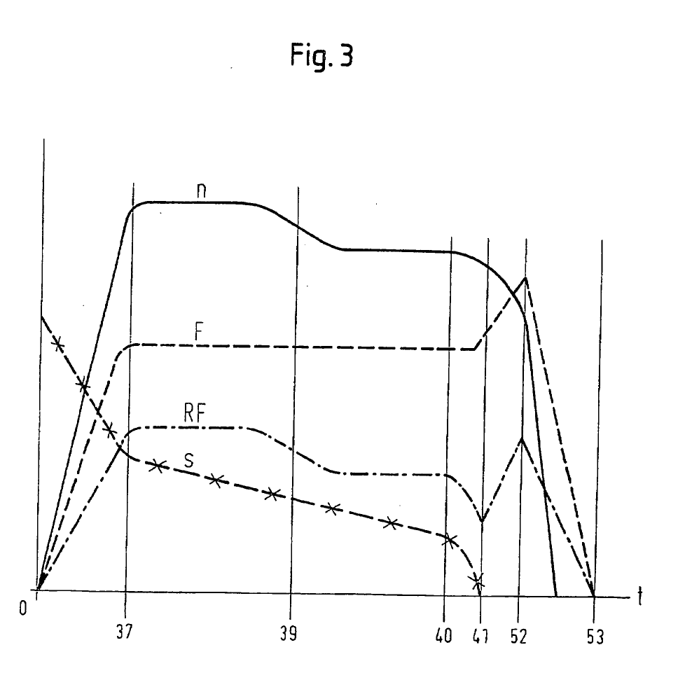

FIG. 3 shows a graph indicating key parameters for the process according to the invention, in relation to the individual process steps;

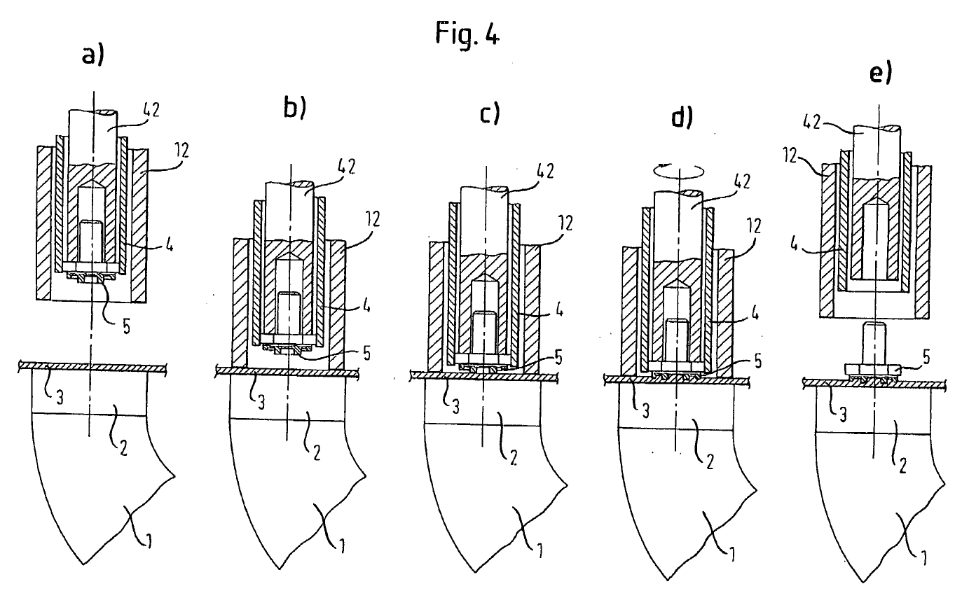

FIG. 4a-e show the successive phases of a friction-welded connection;

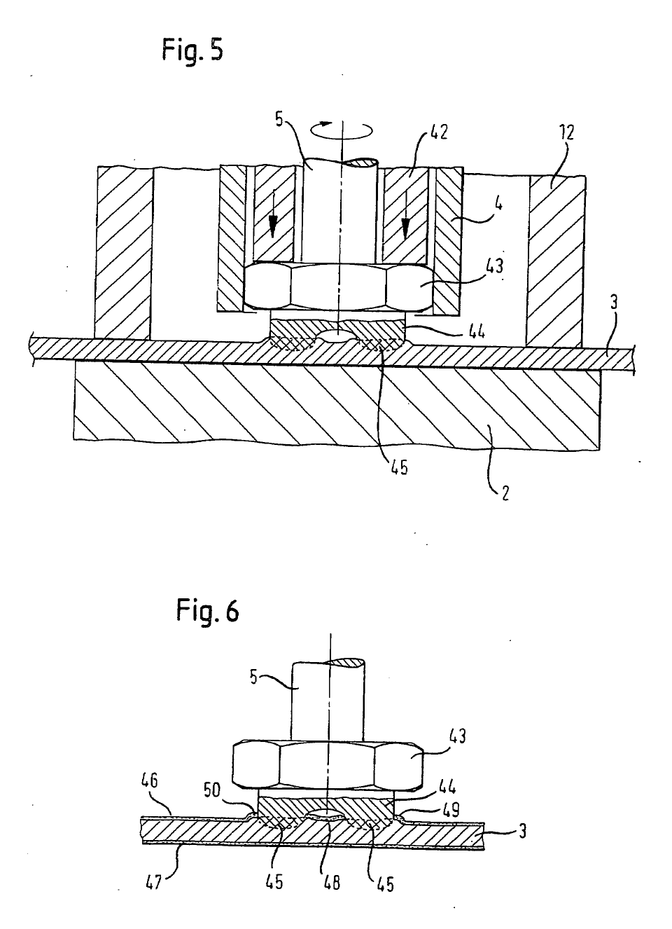

FIG. 5 shows the friction-welded connection of a stud to a panel;

FIG. 6 shows the friction-welded connection of a stud to a coated panel;

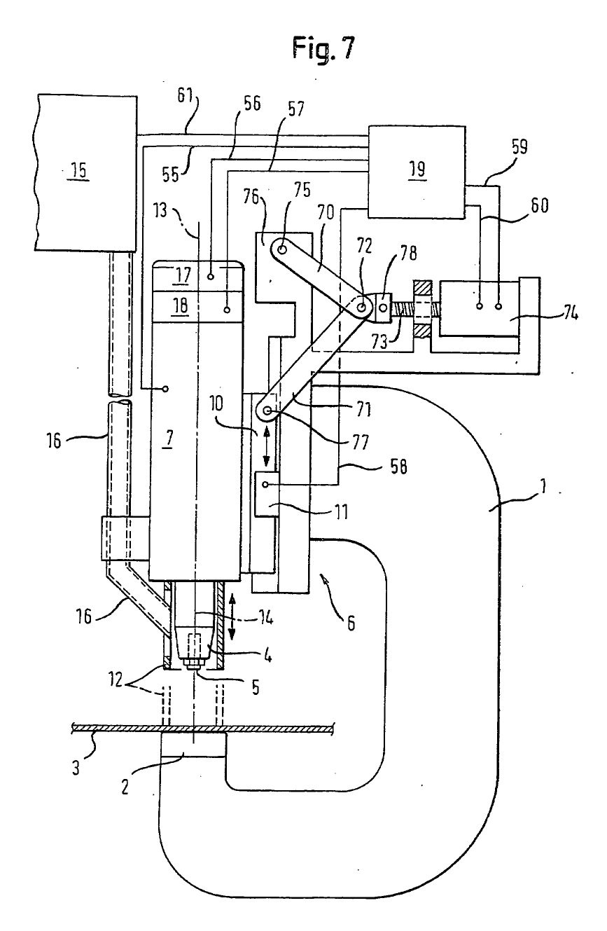

FIG. 7 shows the design of the pressing-force actuator using a toggle joint connection.

The device presented in FIG. 1 is a design which is used for the friction-welding of a stud 5 to a panel 3, this being only an illustrative embodiment of such a device, since the process according to the invention can also be implemented using other devices which may need to be of appropriately different design in relation to the components that are to be welded together. In principle, however, there are always basically similar or the same basic constituent parts.

The device comprises the C-shaped arm 1, which is provided at its one end with the abutment 2 for the panel 3, to which panel 3 is to be welded the stud, which is held by the chuck 4. The other end of the arm C merges into the feed apparatus 6, which carries the electric motor 7, which contains the pressing-force actuator 8a. Accordingly, the feed apparatus 6 is stationary in relation to the abutment 2, since, as stated, the feed apparatus 6 and the abutment 2 are rigidly interconnected by the arm 1. The feed apparatus 6 contains the feed drive 8, which extends through the ram 9 into the sliding part 10 and moves said sliding part 10, according to the feed drive 8, linearly towards the ram 9. During said movement, the sliding part 10 linearly takes with it the thereto attached electric motor 7, this resulting in the corresponding linear movement of the chuck 4 with the stud, which is held by the chuck 4. In order to indicate the respective longitudinal displacement of the electric motor 7 with the stud 5 in relation to the feed apparatus 6, the travel sensor 11 is attached to the sliding part 10, wherein, upon linear displacement of the sliding part 10 in relation to the feed apparatus 6, said travel sensor 11 is displaced and thereby indicates the length of said displacement as the feed depth. For the displacement of the electric motor 7 and therefore of the chuck 4, the feed drive 8 is provided with the pressing-force actuator 8a, which, on the one hand, brings about the aforementioned displacement with regard to a precisely adjusted length as well as the therefor required pressing force. This function of the pressing-force actuator 8a will be more fully discussed in connection with FIG. 2.

The chuck 4 is surrounded by the downholder 12, which, upon downward movement of the electric motor 7 with the chuck 4 and a therein held stud 5, moves towards the panel 3 and, finally, at the end of said movement, comes down on the panel 3, as a result of which the panel 3 is stably locked in position in relation to the electric motor 7 with the chuck 4 and therein held stud 5. With the downholder 12 in this position (indicated by a dashed line), the device is then ready for the friction-welding process.

The rotation axis 13 (indicated by a dashed line) of the electric motor 7 is aligned with the axis 14 (indicated by a dashed line) of the chuck 4 and therefore transitions into the rotation axis of the stud 5. In the device presented in FIG. 1, the rotation axis 13 of the electric motor 7 is rigidly connected to the chuck 4. It should, however, also be pointed out that, particularly where high-speed electric motors are used, it is possible to insert a non-slip gear unit between the rotation axis 13 of the electric motor 7 and the chuck 4.

To allow the chuck 4 to be automatically loaded with the studs 5 which are to be processed, there is provided the feeder 15, which contains a large number of studs to be processed, said studs then being introduced from the feeder 15 via the flexible feeding channel 16 into the chuck 4.

The electric motor 7 is further provided with the force sensor 17 and the torque sensor 18, the modes of operation of which will be more fully discussed in connection with the description with respect to FIG. 2. Electric motor 7, pressing-force sensor 17, torque sensor 18, travel sensor 11, feed drive 8, pressing-force actuator 8a and the feeder 15 are connected to the controller 19 by means of the wires 55, 56, 57, 58, 59, 60 and 61. The modes of operation thereof will likewise be more fully discussed in connection with FIG. 2.

FIG. 2 presents the electric motor 7 with the therewith connected design parts in greater detail. The electric motor 7 contains the stator winding 20 and the rotor 21. The rotor 21 is seated on the shaft 22, which extends into the chuck 4. The stud 5 is engaged by the chuck 4. The chuck 4 is surrounded by the downholder 12, which is urged forward by the springs 23 and 24 and presses against a panel (not shown in FIG. 2) (see FIG. 1, panel 3). In FIG. 2, the downholder 12 is presented in its leading position, out of which, upon coming down on the panel (see FIG. 1), it is forced back into a position in which it presses the panel against the abutment 2, the front end of the stud 5 being aligned with the edge 38 of the downholder 12, the springs 23 and 24 being correspondingly compressed and clamping the component 3 against the abutment 2.

The shaft 22 of the electric motor 7 is held radially on the ball bearing 25. In addition, the electric motor 7 is supported in the axial direction by the thrust bearing 26, which, on the one hand, is in contact with a collar 27 of the housing 28 and presses against a flange 29 of the shaft 22. Arranged at the end of the shaft 22 facing away from the chuck 43 are the torque sensor 30 and the pressing-force sensor 31, which in known manner supply their measured values (torque, pressing force) and transmit said values, as presented in FIG. 1, to the controller 19.

The housing 28 is adjacent to the pressing-force sensor 31 and is closed off by the cover 32. Also mounted on the shaft 22 is the flange 33, which engages with teeth (not shown) in the speed sensor 34, said speed sensor 34 indicating a signal of the speed of the electric motor 7.

As is further presented in FIG. 1, attached at the side to the housing 28 of the electric motor 7 is the sliding part 10, which is moved linearly by the feed apparatus 6 in the axial direction of the motor 7. To allow for such mobility, the sliding part 10 is held on the longitudinal rollers 35. Its displacement is measured by the travel sensor 11 and is effected through operation of the feed drive 8, said feed drive 8 acting on the sliding part 10 via the ram 9. By means of the screws 36, the feed apparatus 6 is attached to the feed drive 8 at the respective end of the C-shaped arm 1.

FIG. 3 presents a graph showing the individual measured values measured by the sensors contained in the device. Therein, the solid line indicates the speed n; the dashed line indicates the axial pressing force F with which the stud 5 is pressed against the panel 3; the dash-dotted line indicates the torque RF supplied by the electric motor 7; and the cross-dashed line indicates the movement s of the stud 5. It is apparent from the graph that, first of all, the electric motor is accelerated with its speed n until, at line 37, it enters the range of its maximum speed. At the same time as it is accelerated with speed n, the electric motor 7 is lowered onto the panel 3 with the parts surrounding the electric motor 7. At the same time, there is a rise in the torque RF, since, namely, at the time of line 37, the stud 5 has reached the panel 3 and there now begins the process of friction-welding with the panel 3 being friction-contacted by the stud 5. At first, the speed n remains essentially the same. During this period of friction, the torque RF and the pressing force F remain essentially at their achieved values until, as a result of part-melting of stud 5 and panel 3, there is a sharp drop in the friction between said two components and therefore in the torque RF (see line 39 in FIG. 3), this being detected by the controller and then being used to reduce the speed, whereas the pressing force F and the reduced torque RF remain virtually unchanged. In the process, the stud 5 penetrates into the panel 3 by, for example, a few tenths of a millimeter, there being formed between stud 5 and panel 3 a desired melt which then, at time 40, reduces the friction between the two components. This is apparent from the drop in torque RF after time period 40, which drop is reported by the torque sensor 17 to the controller 19. Thereupon, the controller 19 increases the pressing force F with a time delay determined by the controller 19, this taking place in the period between time 40 and time 41. With the increase in the pressing force F, the torque RF rises again until time 52, at which the speed n has been extensively reduced, with the result that, starting at time 52, the pressing force F is reduced by the controller and is finally returned to the value 0. At the same time, both through the reduction of speed n and the reduction of pressing force F, also the torque RF is reduced and likewise reaches the value 0 when also the speed has reached the value 0. At this time 53, the part-melted stud has strongly welded with each other.

FIGS. 4a-e present the successive phases of production of a friction-welded connection, FIG. 4a showing the front end of the device from FIG. 1 in its initial position, in which the chuck 4, with therein clamped stud 5, is at some distance from the panel 3, the chuck 4 with the stud 5 being surrounded by the downholder 12. The downholder 12 is shown in a leading position (see FIG. 1), out of which, upon coming down on the panel 3, it is forced back into a position as presented in FIG. 4c. The chuck 4 additionally contains the thrust bolt 42, which, as part of the chuck 4 (not shown in FIGS. 1 and 2), exerts the above-described pressing pressure on the stud 5 which is to be welded.

FIG. 4b shows the arrangement from FIG. 4a in a position in which the downholder 12 has come down on the panel 3 and is pressing the panel 3 against the abutment 2.

After the operating phase according to FIG. 4b, the stud 5 is, as presented in FIG. 4c, now moved further by the chuck 4 towards the panel 3 until, with its region intended for the friction-welding operation, the stud 5 contacts the panel 3, whereupon the friction-welding operation can begin, the downholder 12 having been forced back further against the springs 23, 24 presented in FIG. 2 and thus exerting a particularly great clamping force on the panel 3 in relation to the abutment 2.

After the phase presented in FIG. 4c, there then follows the friction-welding operation (presented diagrammatically in FIG. 3) through activation of the electric motor 7 and consequent rotation of the stud 5 with the initial speed, this leading to the friction (described in connection with FIG. 3) and part-melting of the respective contact surfaces of stud 5 and panel 3, the stud 5 penetrating a short distance into the panel 3 and, at the end of the operation, finally being strongly welded to the panel 3, as is presented in FIG. 4 d.

Upon completion of the operating phase presented in FIG. 4d, the chuck 4 and the downholder 12 can now be moved away from the panel, as is presented in FIG. 4e, the stud 5 being released by the chuck 4 and remaining strongly welded to the panel 3.

FIG. 5, which shows the device in the operating phase according to FIG. 4 d, presents the finished, strong friction-welded connection of the stud 5 to the panel 3. The stud 5 consists here of a shank with adjoining hexagon 43 and welding ring 44, which welding ring 44 projects axially away from said hexagon 43. Said three constituent parts are of integral one-piece design. The welding ring 44 is a short projection disposed axially in relation to the overall stud 5, said projection coming down with its frontal surface on the panel 3 for the friction-welding operation, said frontal surface and the thereto facing surface of the panel 3 forming the two contact surfaces for the friction-welding operation. Such design of stud 5 and panel 3, in combination with use of the hereinbefore described process according to the invention, results in a particularly thin welding zone 45, which makes it possible for the friction-welding process according to the invention also to be employed for especially thin panels. Such panels are used above all in body construction in the automobile industry.

FIG. 6 presents a finished friction-welded connection of a stud, as presented in FIG. 5, and a panel 3, wherein said panel 3 has, prior to the friction-welding operation, been provided on each of its two sides with thin respective coatings 46 and 47. Such thin coatings are likewise employed in automobile body construction, since, frequently, paint-coated metal body panels form the basis of a body shell. As shown in FIG. 6, the coating 46 has been penetrated during the friction-welding operation, there being formed heated and shrunk parts 48, 49 and 50 from the coating 46, said parts having been left next to the friction-welding zone 45. The friction-welding zone 45 transitions from the ring 44 directly into the inner material of the panel 3, this resulting in an especially strong, pore-free friction-welded connection, this additionally having the particular advantage that, owing to said friction-welded connection being concentrated on the relatively thin zone of the friction-welding zone 45, there is virtually no through-heating of the panel 3 and therefore also no damage to the coating 47 on the rear side of the panel 3.

FIG. 7 presents a device for implementing the process according to the invention, said device employing a special type of pressing-force actuator. In this connection, reference should be made, first of all, to the above-cited prior art (DE 199 02 357 A1), in which a hydraulic cylinder is concretely mentioned as the pressing-force actuator and in which, furthermore, it is pointed out that the pressing-force actuator may also be of any other suitable design. The pressing-force actuator employed in the device according to FIG. 7 is a toggle joint connection with the two articulated levers 70 and 71. Said two articulated levers are united in the joint 72, which is engaged by the threaded adjusting rod 73. The threaded adjusting rod 73 is actuated by the servo-motor 74. The joint 75, facing away from the joint 72, has an articulated connection to the upper end portion 76 of the feed apparatus 6. Said upper end portion 76 is stationary, with the result that the articulated lever 70 is able to support itself against the upper end portion 76. The joint 77 of the articulated lever 71 has an articulated connection to the sliding part 10, with the consequence that a pressure or tension exerted by the articulated lever 71 on the sliding part 10 results in the movement of the sliding part 10 as indicated by the arrows.

The mode of operation of said toggle joint connection is as follows: as the threaded adjusting rod 73 is rotated and therefore moves towards the feed apparatus 6, the two joints 75 and 77 move away from each other, wherein, because of the stationary position of the upper end portion 76, the joint 77 inevitably moves in a downward direction, i.e. towards the component 3, it being the case that, depending on the angle formed by the two articulated levers 70 and 71, a more or less strong pressure can be exerted on the sliding part 10. In order to permit a necessary circular motion of the articulated lever 70 about the joint 75, said joint 75 forming a mid-point for the rotational movement, the threaded adjusting rod 73 is provided with a correspondingly acting swivel joint 78.

The device is basically controlled in the same manner as was described in connection with FIG. 1, with merely the two wires 59 and 60 being connected to the servo-motor 74.

With the toggle joint connection with the two articulated levers 70 and 71, it is possible to achieve a very accurate displacement of the sliding part 10, it also being possible at the same time for high forces to be exerted on the sliding part 10, with the result that the toggle joint connection offers an especially advantageous design of those parts of the device which are responsible for the feeding movement the chuck 4 with the stud 5.

Experiments have demonstrated that the hereinbefore described process according to the invention can be implemented using the below-given process values:

Initial speed n=10,000 rpm;

Torque RF=20-40 N/m;

Pressing force F=3-10 KN;

Travel s of the driven component during the friction-contacting of the components s=0.4-0.8 mm;

Timespan for the friction-contacting of the components t=0.5-5 sec.

The above-specified process values serve as an example. These values may vary depending on the materials of the components and on the size of their contact surfaces. At any rate, this is a friction-welding process of particularly short duration, said process being further characterized by the fact that it requires only a slight shortening of the driven component and a very small penetration depth for the component.

1. Process for the friction-welding of components (3, 5) in which, during a heating phase and under reciprocal axial pressing force F produced by a pressing-force actuator (8a), the two components (3, 4) are rotated in relation to each other at the site to be welded, one component (3) being stationary and the driven component (5) being rotated, wherein, furthermore, after sufficient friction heating of the components (3, 5), the rotation is braked and the components (3, 5), stationary with respect to each other, are pressed together with considerably greater pressing force than during the heating phase, the rotated component (5) being driven by an electric motor (7) provided with a controller (19), the speed (n), torque (RF), pressing force (F) and feed depth (s) of said electric motor (7) being measured by the controller (19), characterized in that, depending on an axial initial pressing force (F) between the two components (3, 5), the speed (n) is adjusted by the controller (19) to an initial speed (n) causing the part-melting of the contact surfaces of the two components (3, 5) and is maintained up until a torque drop occurring as a consequence of melting of the contact surfaces of the two components (3, 5), upon which torque drop the speed is lowered and reduced down to a standstill, wherein, at the end of reduction, the pressing force (F) is increased up to a maximum so that the strong welded connection (45) is achieved at the contact surfaces of the two components (3, 5).

2. Device for implementing the process according to claim 1, characterized in that the axis (22) of the electric motor (7) transitions axially into the rotation axis of the driven component (5).

3. Device according to claim 2, characterized in that the electric motor (7) and the driven component (5) are axially rigidly interconnected.

4. Device for implementing the process according to claim 1, characterized in that a non-slip gear unit is connected between the electric motor (7) and the driven component (5).

5. Device according to claim 2, characterized in that the electric motor (7) is carried by a linear feed apparatus (6), said feed apparatus (6) having the pressing-force actuator (8a).

6. Device according to claim 5, characterized in that the electric motor (7) is provided with a pressing-force sensor (17).

7. Device according to claim 2, characterized in that the connection of electric motor (7) and feed apparatus (6) is provided with a travel sensor (11).

8. Device according to claim 7, characterized in that the electric motor (7), the travel sensor (11), the torque sensor (18) and the pressing-force sensor (17) are connected into a control loop containing the controller (19) and supply the controller (19) with their measured data indicating the torque (RF), speed (n), travel (s) and pressing force (F), wherein the electric motor (7) and the feed apparatus (6) are adjusted on the basis of the measurement of said measured data.

9. Device according to claim 2, characterized by a receiving means (4) for the stud (5) forming the driven component and by an abutment (2) for panel-type components (3) as the stationary component.

10. Device according to claim 9, characterized in that the abutment (2) has a flat surface.

11. Device according to claim 9, characterized by a downholder (12), said downholder (12) pressing the panel-type component (3) against the abutment (2).

12. Device according to claim 2, characterized in that a feeding device (15) is provided for feeding the studs (5).

13. Device according to claim 2, characterized in that the abutment (2) is connected to the feed apparatus (6) by a C-shaped arm (1).

14. Device according to claim 5, characterized in that the pressing-force actuator is in the form of a toggle joint connection, the articulated levers (70, 71) of which toggle joint connection move either towards or away from each other by a threaded adjusting rod (73) during motor-driven rotation.

15. Device according to claim 3, characterized in that the electric motor (7) is carried by a linear feed apparatus (6), said feed apparatus (6) having the pressing-force actuator (8a).

16. Device according to claim 4, characterized in that the electric motor (7) is carried by a linear feed apparatus (6), said feed apparatus (6) having the pressing-force actuator (8a).

17. Device according to claim 3, characterized in that the connection of electric motor (7) and feed apparatus (6) is provided with a travel sensor (11).

18. Device according to claim 4, characterized in that the connection of electric motor (7) and feed apparatus (6) is provided with a travel sensor (11).

19. Device according to claim 5, characterized in that the connection of electric motor (7) and feed apparatus (6) is provided with a travel sensor (11).

20. Device according to claim 6, characterized in that the connection of electric motor (7) and feed apparatus (6) is provided with a travel sensor (11).
